(19) United States
(12) Patent Application Publication
(10) Pub. No.: US 2022/0064800 A1
(43) Pub. Date: Mar. 3, 2022

(54) SURFACE TREATMENT METHOD FOR METAL MEMBER

(71) Applicant: TOYOTA JIDOSHA KABUSHIKI KAISHA, Toyota-shi (JP)

(72) Inventor: Kohei SAKURAI, Toyota-shi (JP)

(73) Assignee: TOYOTA JIDOSHA KABUSHIKI KAISHA, Toyota-shi (JP)

(21) Appl. No.: 17/396,828

(22) Filed: Aug. 9, 2021

(30) Foreign Application Priority Data
Aug. 31, 2020 (JP) 2020-145528

(51) Int. Cl. C23C 18/18; H01M 8/0228

(52) U.S. Cl. CPC C23C 18/1803; H01M 8/0228

(57) ABSTRACT

A surface treatment method for a metal member includes the steps of: (a) imparting a charge to one region of the metal member; and (b) forming a first coating by applying a first coating material to the other region of the metal member, the first coating material containing an insulating resin.

### CROSS-REFERENCE TO RELATED APPLICATIONS

This application claims priority based on Japanese Patent Application No. 2020-145528 filed on Aug. 31, 2020, the entire disclosure of which is incorporated herein by reference.

### BACKGROUND

### Field

The present disclosure relates to a surface treatment method for a metal member.

### Related Art

Existing fuel cell separators include one that has a conductive corrosion-resistant coating on a surface of a metal base member (JP2010-123431A). The publication proposes the use of carbon materials, such as carbon particles and carbon nanotubes, for such a conductive corrosion-resistant coating.

One known exemplary method for applying a coating material onto a base member is as follows. First, the base member is masked by a jig on its portions where the coating material is not to be applied. Then, the coating material is applied to other portions of the base member that are not masked by the jig. Finally, the coating material is pressed against and bonded to the base member by a heat press. However, this method may cause adhesion of foreign matters onto the base member through contact between the jig and the base member. Also, the method requires cleaning of the jig in order to apply the coating material to multiple base members. As such, there is room for improvement in the method for applying the coating material. This is a problem encountered not only by surface treatment for fuel cell separators but also by surface treatment for metal base members in general.

### SUMMARY

The present disclosure may be implemented in following aspects.

(1) An aspect of the present disclosure is a surface treatment method for a metal member. The method includes the steps of: (a) imparting a charge to one region of the metal member; and (b) forming a first coating by applying a first coating material to an other region of the metal member, the first coating material containing an insulating resin.

According to the method of this aspect, when the first coating material containing an insulating resin is applied to the metal member, wettability of the resin allows the first coating material to adhere easily to the other region which is an uncharged region, whereas the first coating material hardly adheres to the one region which is a charged region. As such, this method can form the coating only on desired portions without the use of a jig. Additionally, the method can prevent adhesion of foreign matters onto the metal member that may otherwise be caused by contact between a jig and the metal member.

(2) In the method of the above aspect, the step (b) may further include removing the charge imparted to the one region after forming the first coating. The surface treatment method may further include the steps of: (c) imparting a charge to at least a part of the other region of the metal member after the step (b); (d) imparting, to a second coating material, a charge that is opposite to the charge imparted to the at least part of the other region of the metal member; and (e) forming a second coating by applying the charged second coating material atop the first coating.

The method of this aspect can form the coating composed of two layers of different materials without the use of masks.

(3) In the method of the above aspect, the step (b) may include forming the first coating by applying the first coating material to the other region of the metal member by spraying.

The method of this aspect enables uniform application of the coating material to the surface of the metal member, as compared to other methods for applying the coating material to the metal member, other than spraying.

(4) Another aspect of the present disclosure is a surface treatment method for a metal member. The method includes the steps of: (a) imparting a charge to one region of the metal member; (b) imparting, to a coating material, a charge that is opposite to the charge imparted to the one region of the metal member; and (c) forming a coating by applying the charged coating material to the one region of the metal member.

According to the method of this aspect, the coating material bears the charge that is opposite to that imparted to the one region of the metal member. When applied to the metal member, the coating material is attracted to the one charged region. Thus, this method can apply the coating to the metal member without the use of a masking jig. Additionally, the method can prevent adhesion of foreign matters onto the metal member that may otherwise be caused by contact between a jig and the metal member.

(5) In the method of the above aspect, the step (a) may include imparting a negative charge to the one region of the metal member, and the step (b) may include imparting a positive charge to the coating material.

(6) In the method of the above aspect, the step (c) may include forming the coating by applying the charged coating material to the one region of the metal member by spraying.

The method of this aspect enables uniform application of the coating material to the surface of the metal member, as compared to other methods for applying the coating material to the metal member, other than spraying.

### BRIEF DESCRIPTION OF THE DRAWINGS

FIG. 1 is a schematic sectional view of a fuel cell including fuel cell separators;

FIG. 2 is a simplified perspective view of the fuel cell separator;

FIG. 3 illustrates a coating;

FIG. 4 depicts steps of a surface treatment method for the fuel cell separator in accordance with a first embodiment;

FIG. 5 illustrates the surface treatment for the fuel cell separator;

FIG. 6 illustrates the fuel cell separator having a first coating material applied thereto;

FIG. 7 depicts steps of the surface treatment method for the fuel cell separator in accordance with a second embodiment;

FIG. 8 illustrates the surface treatment for the fuel cell separator;

FIG. 9 illustrates the fuel cell separator having a first coating material applied thereto;

FIG. 10 depicts steps of the surface treatment method for the fuel cell separator in accordance with a third embodiment; and

FIG. 11 illustrates a coating in the third embodiment.

### DETAILED DESCRIPTION

### A. First Embodiment

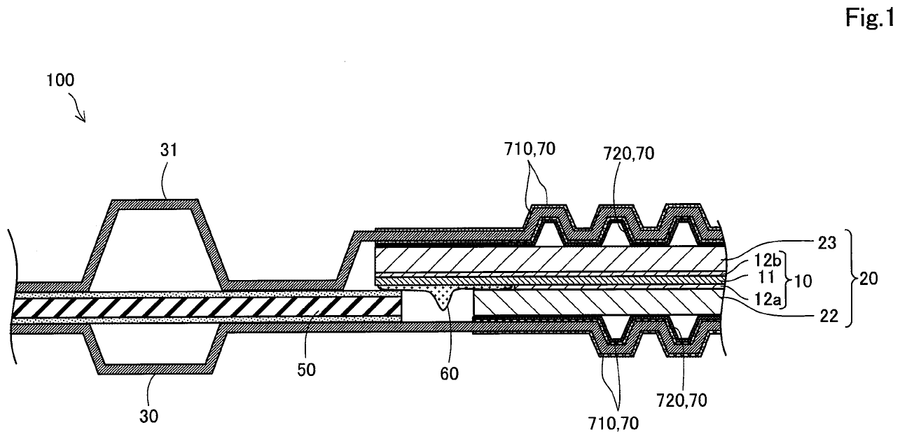

FIG. 1 is a schematic sectional view of a fuel cell 100 including fuel cell separators 30, 31. The fuel cell 100 is a polymer electrolyte fuel cell that generates power by being supplied with a reaction gas composed of hydrogen gas as a fuel gas and air as an oxidation gas. The fuel cell 100 includes a membrane electrode gas-diffusion-layer assembly (hereinafter referred to as MEGA) 20, a resin frame 50, an adhesive 60, and two fuel cell separators 30, 31. The fuel cell 100 is assembled by sandwiching the MEGA 20 and the resin frame 50 between the two fuel cell separators 30, 31. While FIG. 1 illustrates one fuel cell 100, more than one fuel cells 100 may be stacked depending on a required output voltage in use.

The MEGA 20 serves as a generator of the fuel cell 100. The MEGA 20 includes a membrane electrode assembly 10, a cathode gas diffusion layer 22, and an anode gas diffusion layer 23. The membrane electrode assembly 10 includes an electrolyte membrane 11, a cathode catalyst layer 12a disposed on one side of the electrolyte membrane 11, and an anode catalyst layer 12b disposed on the other side of the electrolyte membrane 11. The electrolyte membrane 11 is a proton-conducting ion exchange resin membrane made of an ionomer having a sulfonic acid group as an end group. For example, a fluorine-based resin, such as Nafion (R), is used for the electrolyte membrane 11.

The cathode gas diffusion layer 22 and the anode gas diffusion layer 23 are conductive members having gas diffusivity. For example, nonwoven carbon cloth or carbon paper may be used for the cathode gas diffusion layer 22 and the anode gas diffusion layer 23. The cathode gas diffusion layer 22 is disposed on the outer surface of the cathode catalyst layer 12a. The anode gas diffusion layer 23 is disposed on the outer surface of the anode catalyst layer 12b.

The resin frame 50 is a flat frame and seals a space between the two fuel cell separators 30, 31 to prevent cross leakage and an electrical short circuit between electrodes. For example, resins, such as PE, PP, PET, and PEN, may be used for the resin frame 50. The resin frame 50 includes, at its center in a plane direction, an opening that allows the MEGA 20 to be disposed therein. The resin frame 50 and the MEGA 20 are bonded together by the adhesive 60. For example, an adhesive containing polyisobutylene or butyl rubber may be used for the adhesive 60.

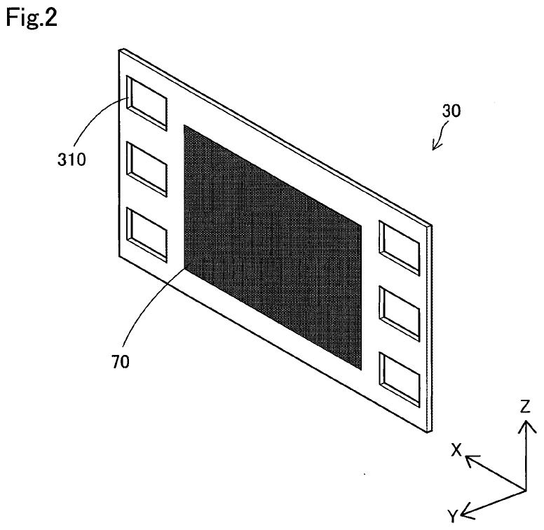

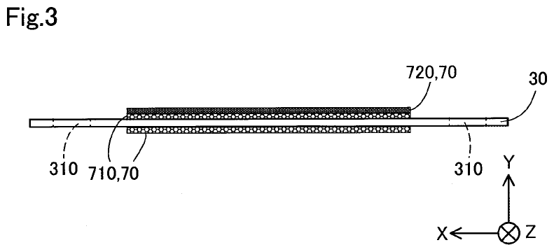

FIG. 2 is a simplified perspective view of the fuel cell separator 30. It should be noted that what is shown in FIG. 2 is not a precise representation of the shape of the fuel cell separator 30. FIG. 2 omits illustration of ridges of the fuel cell separator 30 depicted in FIG. 1. This holds for FIGS. 3, 5, 6, 8, 9, and 11 discussed later. As shown in FIG. 2, the fuel cell separator 30 is formed with a plurality of manifold holes 310. The manifold holes 310 allow the fuel gas, the oxidation gas, or a cooling medium to flow to the membrane electrode assembly 10. The fuel cell separator 30 is a metal member. In the present embodiment, the fuel cell separator 30 is made of SUS (stainless steel). The fuel cell separator 30 includes a coating 70.

FIG. 3 illustrates the coating 70. The fuel cell separator 30 is in contact with the cathode gas diffusion layer 22 of the MEGA 20 (see FIG. 1). The fuel cell separator 30 is formed with the coating 70 at its center in the plane direction (see FIG. 3). The coating 70 is composed of a first coating 710 and a second coating 720.

The first coating 710 is formed on each side of the fuel cell separator 30. The first coating 710 is formed on a portion of the fuel cell separator 30 contacting a power generating region of the MEGA 20 and on the side opposite to that portion (see FIGS. 1 and 3). The second coating 720 is formed on the first coating 710 that is formed on the side of the fuel cell separator 30 contacting the power generating region of the MEGA 20 (see FIG. 3). Dimensions of the second coating 720 in X, Y, and Z directions are the same as those of the first coating 710. It should be noted that the dimensions of the second coating 720 may differ from those of the first coating 710. Details of the first coating 710 and the second coating 720 will be given later.

The fuel cell separator 31 is in contact with the anode gas diffusion layer 23 of the MEGA 20 (see FIG. 1). The shape and number of ridges and grooves of the fuel cell separator 31 differ from the shape and number of those of the fuel cell separator 30. Similarly to the fuel cell separator 30, the fuel cell separator 31 is formed with the first coating 710 on its portion contacting the power generating region of the MEGA 20 and on its side opposite to that portion. Also, the second coating 720 is formed on the first coating 710 that is formed on the side of the fuel cell separator 31 contacting the power generating region of the MEGA 20. In the present embodiment, the area of the coating 70 formed on the fuel cell separator 31 is larger than that of the coating 70 formed on the fuel cell separator 30. It should be noted that the coatings 70 formed on these two fuel cell separators may have the same area. The fuel cell separator 31 is a metal member. In the present embodiment, the fuel cell separator 31 is made of SUS.

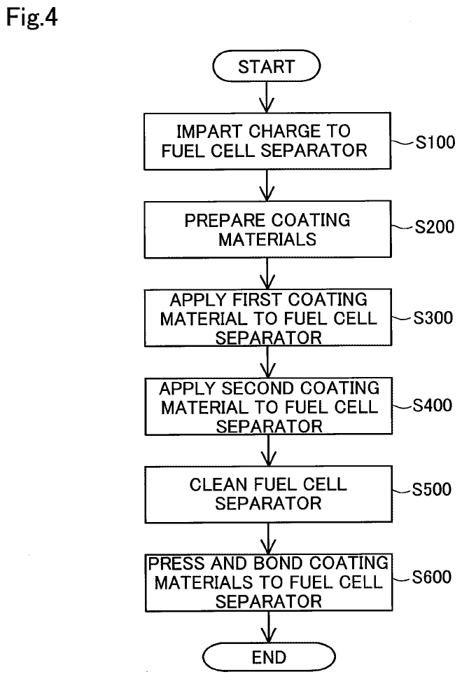

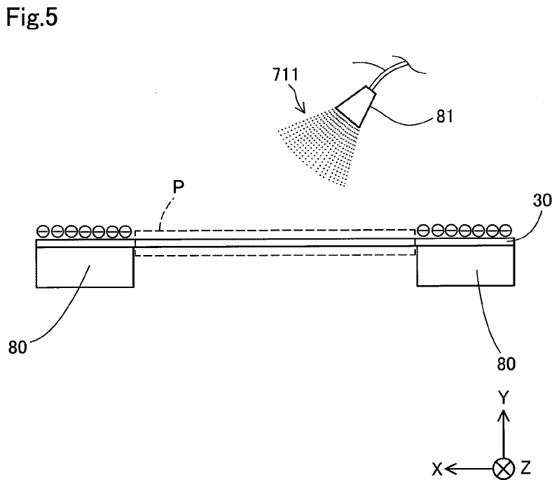

FIG. 4 depicts steps of the surface treatment method for the fuel cell separator 30 in accordance with the first embodiment. FIG. 5 illustrates the surface treatment for the fuel cell separator 30. At step S100, a charge is imparted to the fuel cell separator 30 (see FIG. 4). More specifically, the fuel cell separator 30 is fixed to an electrostatic chuck 80, as shown in FIG. 5. The electrostatic chuck 80 is a device that applies voltage to its internal electrodes to thereby attract and hold an object by a Coulomb force. The electrostatic chuck 80 gives rise to the Coulomb force on a surface of the fuel cell separator 30 in contact with the electrostatic chuck 80. In the present embodiment, a negative charge is imparted by the electrostatic chuck 80 to one region of the fuel cell separator 30 (see FIG. 5). Step 5100 only involves the impartation of the charge to the fuel cell separator 30, and does not involve application of a first coating material 711 shown in FIG. 5.

At step S200 in FIG. 4, materials of the first coating 710 and the second coating 720 are prepared. The material of the first coating 710 is hereinafter referred to as a first coating material 711. In the present embodiment, the first coating material 711 is a mixture of titanium particles and an epoxy resin. Titanium particles have a function of increasing conductivity of carbon particles contained in the second coating 720. Titanium particles may be replaced with silver, gold, tungsten, or carbon, for example. The epoxy resin prevents deterioration of the electrolyte membrane 11 while iron ions elute from the SUS constituting the fuel cell separator 30 through the use or aging of the fuel cell 100 and may otherwise erode the electrolyte membrane 11.

The material of the second coating 720 is hereinafter referred to as a second coating material 721. The second coating material 721 is a mixture of carbon particles and an epoxy resin. Carbon particles have conductivity and provide corrosion resistance to the fuel cell separator 30. Carbon particles may be replaced with other conductive materials such as carbon materials including carbon nanotubes, carbon nanofibers, and carbon nanohorns. Mixing an epoxy resin with titanium particles or carbon particles eliminates the need for forming a coating of titanium particles or carbon particles separately from a coating of the epoxy resin. Hence, such a mixture can improve productivity of forming the coating 70.

A method for producing the first coating material 711 will be described. First, titanium particles and an epoxy resin are mixed at the ratio of 2:1 to give a liquid mixture. This first coating material 711 is repeatedly pulverized and stirred in a jet mill for 30 minutes, whereby titanium particles are pulverized and dispersed in the mixture. In the mixture of the epoxy resin and titanium particles, the titanium particles are considered to be coated with the epoxy resin. The titanium particles and the epoxy resin may be also mixed at a ratio of 1:1. The second coating material 721 is produced in the same manner as that for the first coating material 711.

At step S300, the first coating material 711 is applied to the fuel cell separator 30. First, the first coating material 711 prepared at step S200 is applied with a spray 81 to the other region of the fuel cell separator 30 (see a region enclosed by a dashed line P in FIG. 5). The other region refers to portions of the surface of the fuel cell separator 30 other than the one region thereof. The first coating material 711 is applied to the single fuel cell separator 30 to form a several-micrometer-thick coating. The spray 81 enables uniform application of the first coating material 711 to the surface of the fuel cell separator 30, as compared to other methods than spraying. Instead of spraying, the first coating material 711 may be applied by an inkjet method, a brush, or the like.

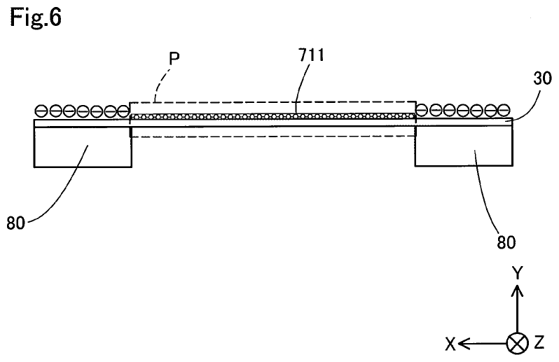

FIG. 6 illustrates the fuel cell separator 30 having the first coating material 711 applied thereto. Here, wettability of an epoxy resin will be discussed. The inventor has found that charging an epoxy resin reduces its wettability. Also, an epoxy resin is known to have high wettability to metals, in particular to stainless steel. Such wettability allows an epoxy resin to adhere easily to the other region of the fuel cell separator 30 which is an uncharged region. On the other hand, the epoxy resin hardly adheres to the one region of the fuel cell separator 30 which is a charged region.

As mentioned earlier, titanium particles are considered to be encased in the epoxy resin. Hence, when the first coating material 711 is applied to the fuel cell separator 30, the first coating material 711 adheres to the other region of the fuel cell separator 30 because of the wettability of the epoxy resin (see a region enclosed by a dashed line P in FIG. 6).

At step S400 in FIG. 4, the material of the second coating 720 is applied to the fuel cell separator 30. In the liquid mixture of carbon particles and an epoxy resin prepared at step S200, the carbon particles are considered to be encased in the epoxy resin. The second coating material 721 is applied atop the first coating material 711 applied to the fuel cell separator 30 at step S300. Since both of the first coating material 711 and the second coating material 721 are liquid as described above, the second coating material 721 easily adheres to the first coating material 711. On the other hand, the second coating material 721 hardly adheres to the one region of the fuel cell separator 30 which is a charged region where the wettability of the epoxy resin is reduced.

At step S500, the first coating material 711 and the second coating material 721 applied to the one region of the surface of the fuel cell separator 30 are removed by cleaning. Examples of the cleaning method includes ultrasonic cleaning with pure water and cleaning with alkaline water. As mentioned earlier, the epoxy resin hardly adheres to the one region. Hence, the first coating material 711 and the second coating material 721 applied to the one region of the fuel cell separator 30 are removed more easily than the first coating material 711 and the second coating material 721 applied to the other region of the fuel cell separator 30. At step S500, the first coating material 711 and the second coating material 721 applied to the one region of the fuel cell separator 30 are removed to such a degree as not to remove the first coating material 711 and the second coating material 721 applied to the other region of the fuel cell separator 30. At step S600, the first coating material 711 and the second coating material 721 applied to the fuel cell separator 30 are pressed against and bonded to the fuel cell separator 30 with a pressure of a few MPa. Consequently, the first coating 710 and the second coating 720 are formed (see FIG. 3).

For this fuel cell separator 30, the first coating 710 is formed also on another side thereof opposite to its side contacting the power generating region of the MEGA 20 (see FIGS. 1 and 3), through the steps depicted in FIG. 4 excluding step S400. The coating 70 is formed on the fuel cell separator 31 in the same manner as the coating 70 on the fuel cell separator 30.

In use, cooling water flows on the surfaces of the fuel cell separators 30, 31 opposite to their respective surfaces contacting the MEGA 20. The inventors have found that disposing a carbon material on the surface of the fuel cell separator contacting the cooling water reduces conductivity of the fuel cell 100. Thus, the inventors have contemplated that a coating to be formed on the surfaces of the fuel cell separators 30, 31 opposite to their respective surfaces contacting the MEGA 20 should contain a material other than carbon materials. For this reason, the sides of the fuel cell separators 30, 31 contacting the cooling water are provided with only the first coating 710 in the present embodiment (see FIG. 1).

It is known that presence of a material, such as an epoxy resin, titanium particles, and carbon particles, on a surface of a fuel cell separator between a resin frame and the fuel cell separator hampers adhesion of the resin frame to the fuel cell separator. Hence, a coating formed on the entire surface of the fuel cell separator may reduce adhesiveness between the fuel cell separator and the resin frame. In this regard, previous methods for forming a coating on the fuel cell separator have included various approaches, for example: partial masking of the fuel cell separator so as to limit coating-formable portions and thereby to prevent the coating from affecting adhesiveness between the fuel cell separator and the resin frame; or partial peeling of a coating after the coating is formed on the entire surface of the fuel cell separator.

However, use of masks in the formation of a coating not only involves a risk of foreign matters adhering to the fuel cell separator through contact between a masking jig and the fuel cell separator, but also requires cleaning of the jig. Meanwhile, the approach of peeling off the coating not only involves a risk of damage on the surface of the fuel cell separator but also requires an additional cost for the peeling. In contrast, the method of the present embodiment can form the coating 70 only on desired portions of the fuel cell separator without the use of a masking jig. In other words, the method can create portions that are not formed with the coating 70, ensuring adhesiveness between each of the fuel cell separators 30, 31 and the resin frame 50. The method can also prevent adhesion of foreign matters to the fuel cell separators 30, 31. Additionally, the method, which does not require cleaning of the jig, can reduce the manufacturing cost for forming the coating 70.

### B. Second Embodiment

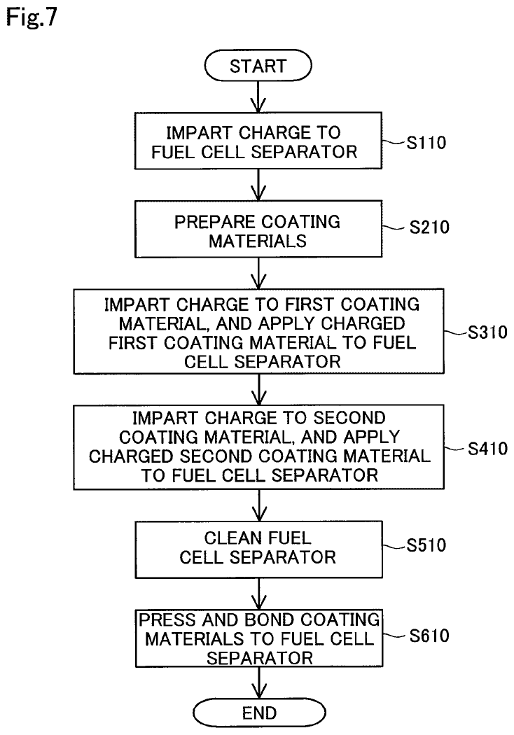

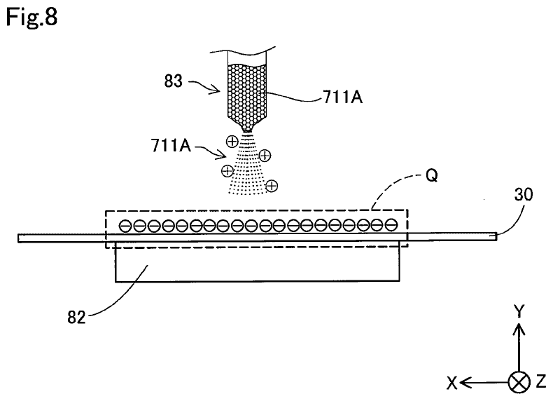

FIG. 7 depicts steps of the surface treatment method for the fuel cell separator 30 in accordance with the second embodiment. FIG. 8 illustrates the surface treatment for the fuel cell separator 30. The second embodiment differs from the first embodiment in the method for forming the coating 70. Similar components to those in the first embodiment are denoted by the same reference numerals, and detailed description thereof will be omitted.

At step S110 in FIG. 7, a charge is applied to one region of the fuel cell separator 30. The “one region” in the second embodiment corresponds to the “other region” in the first embodiment. First, as shown in FIG. 8, an electromagnetic induction generator 82 is fixed at a surface portion of the fuel cell separator 30, and a Coulomb force is generated on the surface portion of the fuel cell separator 30 contacting the electromagnetic induction generator 82 (see a region enclosed by a dashed line Q in FIG. 8). In the present embodiment, a negative charge is imparted by the electromagnetic induction generator 82 to the fuel cell separator 30. Step S110 only involves the impartation of the charge to the fuel cell separator 30, and does not involve application of a coating material using an electrostatic spray 83 (described later) shown in FIG. 8.

At step S210 in FIG. 7, the first coating material 711 and the second coating material 721 are prepared. The method for preparing the first coating material 711 and the second coating material 721 at step S210 is the same as that at step S200 in the first embodiment. At step S310, a charge is imparted to the first coating material 711, and the charged first coating material 711 is applied to the fuel cell separator 30. First, a voltage of several thousand volts is applied to the first coating material 711 fed in a nozzle of the electrostatic spray 83 (see FIG. 8), thereby charging the first coating material 711. This charged material for the first coating 710 is hereinafter referred to as a first coating material 711A. In the present embodiment, the first coating material 711A is imparted with a positive charge that is opposite to the negative charge imparted to the one region of the fuel cell separator 30. The first coating material 711A is ejected from the nozzle of the electrostatic spray 83 and applied to the fuel cell separator 30. The electrostatic spray 83, which is employed to apply the first coating material 711A to the one region of the fuel cell separator 30, enables uniform application of the first coating material 711A to the surface of the fuel cell separator 30, as compared to other methods than spraying.

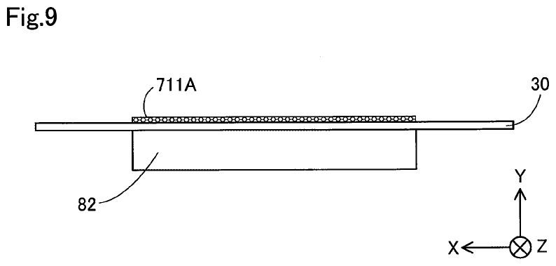

FIG. 9 illustrates the fuel cell separator 30 having the first coating material 711A applied thereto. FIG. 9 omits illustration of the positive charge and the negative charge. As mentioned earlier, the first coating material 711A bears the positive charge that is opposite to the negative charge imparted to the one region of the fuel cell separator 30. Upon being applied to the fuel cell separator 30, the first coating material 711A is attracted to the one region of the fuel cell separator 30 which a negatively charged region. Hence, the first coating material 711A is applied in a larger amount to the one region of the fuel cell separator 30 which is a negatively charged region than to the other region thereof which is not negatively charged.

At step S410, a positive charge is imparted to the second coating material 721, and the charged second coating material 721 is applied to the fuel cell separator 30. The positively charged second coating material 721 is hereinafter referred to as a second coating material 721A. Then, the second coating material 721A is applied atop the first coating material 711A. At step S510, the surface of the fuel cell separator 30 is cleaned by the same cleaning method as that at step S500 in the first embodiment. In the other region of the fuel cell separator 30 which is not negatively charged, the first coating material 711A and the second coating material 721A applied thereto are not attracted to the fuel cell separator 30 by the Coulomb force. Hence, the first coating material 711A and the second coating material 721A applied to the other region of the fuel cell separator 30 can be removed more easily than the first coating material 711A and the second coating material 721A applied to the one region of the fuel cell separator 30 which is the negatively charged region.

At step S610, the first coating material 711A and the second coating material 721A applied to the fuel cell separator 30 are pressed against and bonded to the fuel cell separator 30 with a pressure of a few MPa. Consequently, the first coating 710 and the second coating 720 are formed on the surface of the fuel cell separator 30 (see FIG. 3). Then, the electromagnetic induction generator 82 is removed from the fuel cell separator 30. For this fuel cell separator 30, the first coating 710 is formed in the same manner on another side thereof that is opposite to the power generating region of the MEGA 20 and that contacts the cooling water. Likewise, the coating 70 is formed also on the fuel cell separator 31. Thus, the second embodiment gives the same advantageous effects as in the first embodiment. That is, the method of the second embodiment can form the coating 70 on the fuel cell separator 30 without the need for a masking jig. The method can thus prevent adhesion of foreign matters to the fuel cell separator 30 while ensuring adhesiveness between the fuel cell separator 30 and the resin frame 50. Additionally, the method, which does not require cleaning of a jig, can reduce the manufacturing cost for forming the coating 70.

### C. Third Embodiment

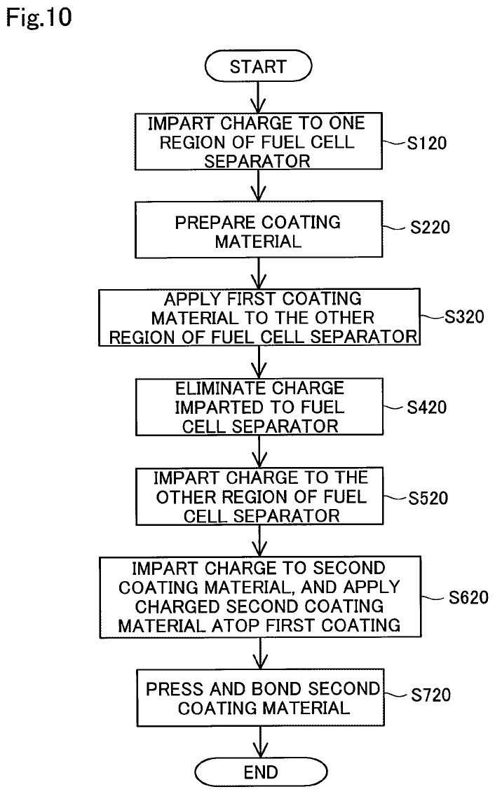

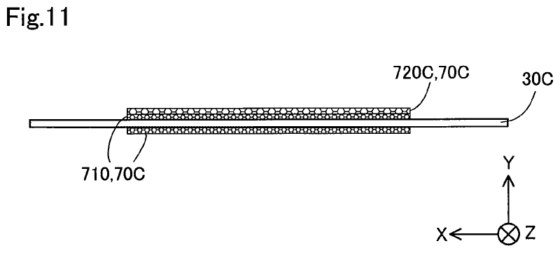

FIG. 10 depicts steps of the surface treatment method for a fuel cell separator 30C in accordance with the third embodiment. FIG. 11 illustrates a coating 70C in the third embodiment. The third embodiment differs from the above embodiments in the method for forming a second coating 720C and the coating 70C. Specifically, the third embodiment differs from the above embodiments, firstly, in that the second coating 720C is composed only of carbon particles and, secondly, in that the first coating 710 is formed by the method of the first embodiment while the second coating 720C is formed by the method of the second embodiment. Similar components to those in the above embodiments are denoted by the same reference numerals, and detailed description thereof will be omitted. The following description of the third embodiment will only discuss formation of the coating 70C on one side of the fuel cell separator 30C that contacts the power generating region of the MEGA 20.

At step S120, a negative charge is imparted to one region of the fuel cell separator 30C. The “one region” in the third embodiment corresponds to the “one region” in the first embodiment. At step S220, the first coating material 711 is prepared. At step S320, the first coating material 711 is applied to the other region of the fuel cell separator 30C to form the first coating 710 thereon. After forming the first coating 710, The first coating material 711 on the one region of the fuel cell separator 30C is washed away to complete the first coating 710. The “other region” in the third embodiment corresponds to the “other region” in the first embodiment. At step S420, the electrostatic chuck is removed to eliminate the negative charge imparted to the one region of the fuel cell separator 30C.

At step S520, a negative charge is imparted to the other region of the fuel cell separator 30C. At step S620, a positive charge is imparted to carbon particles to produce a second coating material 721C. The second coating material 721C is applied atop the first coating 710, and the fuel cell separator 30C is cleaned. At step S720, the second coating material 721C is pressed against and bonded to the first coating 710.

In the third embodiment, the first coating 710 is made of a mixture of an epoxy resin and titanium particles, and the second coating 720C is made of carbon particles. As such, the coating 70C composed of two layers of different materials can be formed without the use of masks.

### D. Alternative Embodiments

D1) In the first embodiment, the first coating material 711 is a mixture of titanium particles and an epoxy resin, and the second coating material 721 is a mixture of carbon particles and an epoxy resin. Instead, the coatings in the first embodiment may be made only of an epoxy resin. Alternatively, the first coating material may be a mixture of an epoxy resin, titanium particles, and carbon particles. Still alternatively, the first coating material may be a mixture of carbon particles and an epoxy resin, and the second coating material may be a mixture of titanium particles and an epoxy resin.

D2) In the first embodiment, a negative charge is imparted to the fuel cell separator 30 by the electrostatic chuck 80. Instead, a positive charge may be applied to the fuel cell separator by the electrostatic chuck. Alternatively, the electromagnetic induction generator may be used in the first embodiment, and the electrostatic chuck may be used in the second embodiment.

D3) In the second embodiment, the first coating material 711A and the second coating material 721A contain an epoxy resin. Instead, the first coating material and the second coating material may be devoid of any epoxy resin in the method of the second embodiment, such that the first coating material and the second coating material may be respectively composed of titanium particles and carbon particles, and the charge opposite to that applied to the fuel cell separator may be applied to each of the first and second coating materials.

In a still alternative embodiment, the first coating material may be titanium particles and the second coating material may be a mixture of carbon particles and an epoxy resin, and the first coating material may be applied to the fuel cell separator by the method of the second embodiment while the second coating material may be applied to the fuel cell separator by the method of the first embodiment.

D4) In the second embodiment, a negative charge is imparted to the fuel cell separator 30, and a positive charge opposite to that negative charge imparted to the fuel cell separator 30 is imparted to the first coating material 711A. Instead, a positive charge may be imparted to the fuel cell separator, and a negative charge may be imparted to the coating material.

D5) In the third embodiment, a charge is imparted to the other region at step S520. Instead, a charge may be applied to at least a part of the other region at step S520.

D6) In the above embodiments, the first coating 710 and the second coating 720 are formed on the surfaces of the fuel cell separators 30, 31 contacting the MEGA 20. Instead, only the first coating may be formed on the surface of each fuel cell separator contacting the MEGA. Alternatively, a third coating made of a material different from those of the first and second coatings may be formed on the second coating. Still alternatively, the coatings may be formed only on one side of each fuel cell separator.

D7) In the above embodiments, the fuel cell separators 30, 31 are made of SUS. Instead, each fuel cell separator may be made of a metal member other than SUS, such as titanium or copper, for example.

D8) The above embodiments make use of an epoxy resin. Instead of an epoxy resin, other insulating resins, such as silicon resins, may be used. The coating material may be in the form of powders.

D9) In the above embodiments, the surface treatment is conducted on the fuel cell separators 30, 31, 30C that are metal members. The surface treatment may also be conducted on various metal members other than the fuel cell separators.

The present disclosure is not limited to the above embodiments and may be implemented in various different ways without departing from the scope of the disclosure. For example, the technical features in the embodiments corresponding to those in the disclosed aspects may be replaced or combined as appropriate in order to address partially or wholly the aforementioned problems or to achieve some or all of the aforementioned advantageous effects. Any of the technical features, unless being described as essential herein, may be omitted as appropriate.

What is claimed is:

1. A surface treatment method for a metal member, the method comprising the steps of:
(a) imparting a charge to one region of the metal member; and
(b) forming a first coating by applying a first coating material to an other region of the metal member, the first coating material containing an insulating resin.

2. The surface treatment method for the metal member according to claim 1, wherein
the step (b) further comprises removing the charge imparted to the one region after forming the first coating, and
the surface treatment method further comprises the steps of:
(c) imparting a charge to at least a part of the other region of the metal member after the step (b);
(d) imparting, to a second coating material, a charge that is opposite to the charge imparted to the at least part of the other region of the metal member; and
(e) forming a second coating by applying the charged second coating material atop the first coating.

3. The surface treatment method for the metal member according to claim 1, wherein
the step (b) comprises forming the first coating by applying the first coating material to the other region of the metal member by spraying.

4. A surface treatment method for a metal member, the method comprising the steps of:
(a) imparting a charge to one region of the metal member;
(b) imparting, to a coating material, a charge that is opposite to the charge imparted to the one region of the metal member; and
(c) forming a coating by applying the charged coating material to the one region of the metal member.

5. The surface treatment method for the metal member according to claim 4, wherein
the step (a) comprises imparting a negative charge to the one region of the metal member, and
the step (b) comprises imparting a positive charge to the coating material.

6. The surface treatment method for the metal member according to claim 4, wherein
the step (c) comprises forming the coating by applying the charged coating material to the one region of the metal member by spraying.
